(19) United States
(12) Patent Application Publication
(10) Pub. No.: US 2018/0204236 A1
(43) Pub. Date: Jul. 19, 2018

(54) Digital Club Marketing Mobile Application

(71) Applicants: CHRISTOPHER DARREN MORGAN, DETROIT, MI (US); Joy Carter, Detroit, MI (US)

(72) Inventors: CHRISTOPHER DARREN MORGAN, DETROIT, MI (US); Joy Carter, Detroit, MI (US)

(21) Appl. No.: 15/409,121

(22) Filed: Jan. 18, 2017

(51) Int. Cl. G06Q 30/02; G06Q 10/10; G06Q 30/06

(52) U.S. Cl. CPC G06Q 30/0214; G06Q 10/1095; G06Q 30/0283; G06Q 30/0282; G06Q 30/0633

(57) ABSTRACT

Spinfire is a digital club-marketing platform delivered on a native mobile application that supports direct targeting to any club or event servicer enabling the ability to manage music campaigns. It was created for the purpose of connecting music Artists with DJ's to have songs played at clubs or events upon demand. It features a “Proof of Play” delivery system whereby DJ's capture the crowd reaction in real time and sends the playback video to the artist using our Proof of Play delivery system for validation of service completion. This product also gives the DJ's a platform by which to hear new music and be compensated for marketing that song to club attendees across the nation.

### BACKGROUND

There is no systematic process in the form of a mobile application for a music artist to request a DJ to play their song in a club in order to promote new material and receive real time audience reaction. There are two primary manual methods today. The first is walking up to DJ's at clubs or events and making requests on the spot. The second is to hope the DJ's come across their music and voluntarily plays it. The former method is limited based on geographical constraints. The latter does not provide instant feedback and may not be the desired marketing conditions of the artist. Through this product artists will be able to connect with DJ's in clubs across the United States to have music of various genres played in the club or event of their choice.

Today there is no systematic process in the form of a mobile application for club DJ's to be compensated directly from a music artist for playing his music in a club. The Spinfire mobile application service will allow the artist to manage their music campaigns directly for a nominal fee and allows them to promote and market their songs nation wide. It gives musicians flexibility and control in that they are able to choose the DJ, the city, and the club, where their music can be heard. It will allow the DJ to receive compensation for playing songs from individual artists in the club.

### BRIEF SUMMARY OF INVENTION

The purpose of this mobile application is to provide a digital marketplace platform for the purpose of matching service requestors (Music Artists) with service providers (DJs). Users submit service requests to specific service providers within the application for the purpose of purchasing the service to market and promote their digital content. Submission of content to be marketed, the review and acceptance of content to be marketed, payment for content to be marketing and the viewing and proof that content was marketed as requested are all contained within the mobile application.

Artists will be able to view the published schedules of DJ's and submit requests to have songs played at that club or event location for the agreed upon fee. Payment is only required upon acceptance of the request and disbursed to DJ's after proof of completion of services are delivered. DJ's will use our “Proof of Play” delivery process to return an audio and visual recording to demonstrate completion of the service request. Artists will have instant access to this video and can then save or share with others. This application gives artists a new option to quickly distribute material directly to the club DJ in order to promote and market at locations of their choosing. It also gives artists direct visual feedback of audience reaction to their material.

### BRIEF DESCRIPTION OF DRAWINGS

FIG. 1 Architecture Diagram—This describes the components of the application. It includes the three-tiered architecture and the interface components.

FIG. 2 Spinfire Artist Submit Play Request Process—This diagram depicts the Spin Request submission process from the artist to the spin request being submitted to the DJ.

FIG. 3—Spinfire DJ Proof of Play Delivery Process. This diagram depicts the Proof of Play Delivery process beginning from the Spin Request being sent to the end of the transaction.

### DETAILED DESCRIPTION

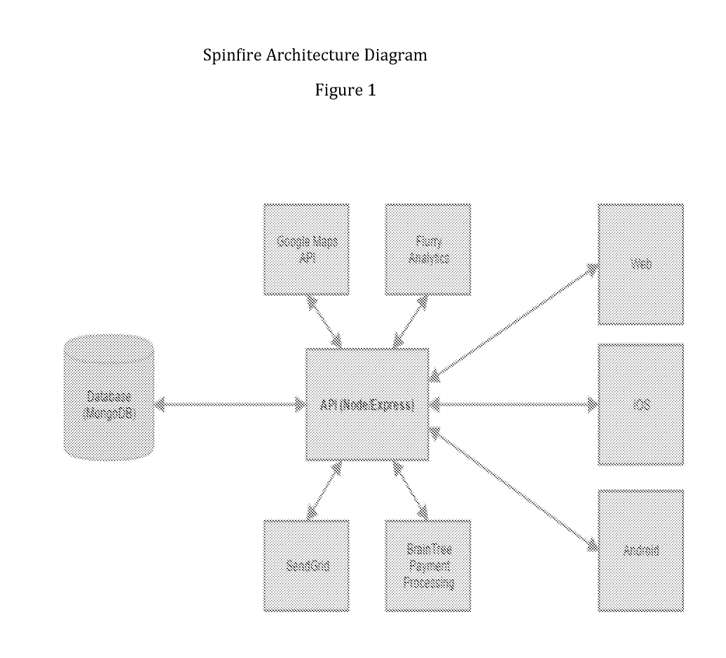

This is a three-tiered application that uses a combination of HTML/CSS and Java API's and web services to connect with the backend database and the infrastructure is provisioned by cloud-based services. The application requires Internet connectivity and a smart phone device. Users are authenticated based on a unique identifier. Transactional notifications are delivered to the DJ's and artists via a third party vendor and are made available through the applications API. Transactional notifications are delivered via SMS text messaging and user is not able to opt out of receiving. A third party vendor provides payment processing and funds distribution. The “Proof of Play” video utilizes the native video functionality within the smart device. See FIG. 1—Spinfire Architecture Diagram.

Service requestors (Artists) and service providers (DJ's) are required to register on the application. They are uniquely identified by email accounts. They are authenticated by user name and passwords. Accounts are authenticated by digital certificates, which are verified through the mobile phone number and device. Service requestors (Artists) set up account profiles describing the genre of the digital content they are marketing as well as listing their hometown.

The searching capability utilizes Google search to return results and suggests cities as users type in the city name. The city and state chosen is then populated in the hometown field.

The account management service allows you to maintain your profile and music content. Service requestors are able to upload up to (5) mp3 files containing the digital content they want to market and promote. Each mp3 file has to meet the quality requirement of 320 bit rates to be accepted. You receive an error message if you have reached the maximum number of allowed songs and attempt to add beyond the allowed number. The mp3 upload process utilizes the functionality native to iPhone. You can retrieve saved mp3 files from file sharing services such as iCloud and or Dropbox. You are also able to use the native email application to access the users attached mp3 file. Using the Share feature and the Open in Application feature the user is able to upload the file to the application directly. The user is able to modify the name of the music file within the application. Service requestors are able to purchase the timeslots from the service provider of choice. This is accomplished by selecting a posted schedule by the service provider (DJ). DJ schedules can be viewed via two screens—Request a Spin and the Community screen.

The search function can be accessed by either the Request a Spin or Community page. Service requestors are able to search by service provider name. Results will return all registered service providers (DJ's) that match that name and that have at least one scheduled event. Service requestors are also able to search by venue. Results will return the schedules for all service providers (DJ's) scheduled at that venue. Service requestors are able to search for service providers by city. Results will return clubs and service providers registered in that city. The searching capability for this functionality incorporates the Google search engine to return results via a Google API.

Service requestors must purchase the service prior to submitting a request to a service provider. This is accomplished by incorporating a purchase process for merchant transactions managed by a third party vendor (TPV). Credit card validation and error handling is triggered by the web service that is exposed to the TPV API.

Service requestors must also have a song uploaded in order to complete the purchase transaction. The digital content submitted by the service requestor is reviewed for format compatibility. This verification is performed by the application. Once this check is completed the purchase process can be submitted.

The music content is delivered to the service provider (DJ) via web services. Successful delivery is made known to the requestor by in app Push Notifications in the form of email and/or text message.

When a service requestor's digital content is delivered to the DJ, the DJ can choose to accept or decline the request. Artists are notified in either case by receipt of in app push notifications. Declines are accompanied by 1 of 3 prescribed reasons for the service providers decline. This is delivered per the preferences managed by the requestor.

Service requestors will receive notice of payment process completion and the receipt delivered via email. The market place merchant third party vendor provides this service.

Service requestors (music artists) who receive a decline will have their account credited. They will be notified via in app push notification. This functionality is enabled through a third party vendor and the application program interface. Service providers post their schedule and location for services, which will be visible to all users within the application.

Service providers set pricing for their services and can be unique for every event location where they offer services.

Service providers can manage, add, update and delete their schedules through the user interface. Updates to the schedule are captured asynchronously through web service calls.

Service providers can record the event within the application via a proof of play delivery system. This allows the provider to capture audio and video of the song playing and the location its being played. The recording capability is accomplished by the video capability native to the smartphone device. The audio file is then retained, tagged and is available for sharing with the requestor.

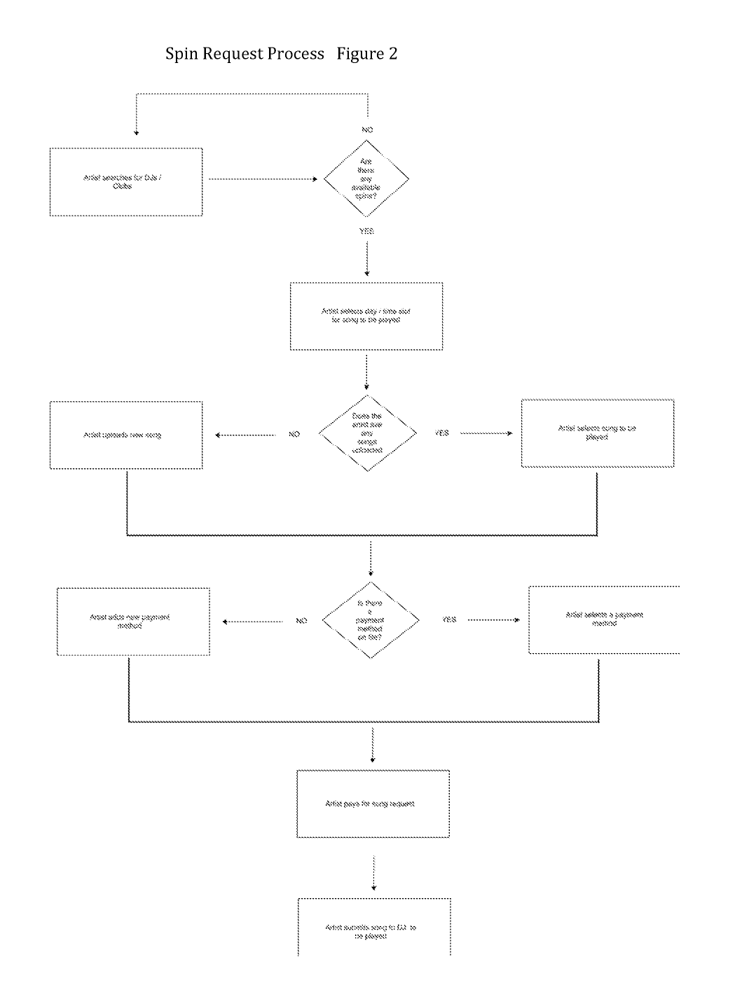

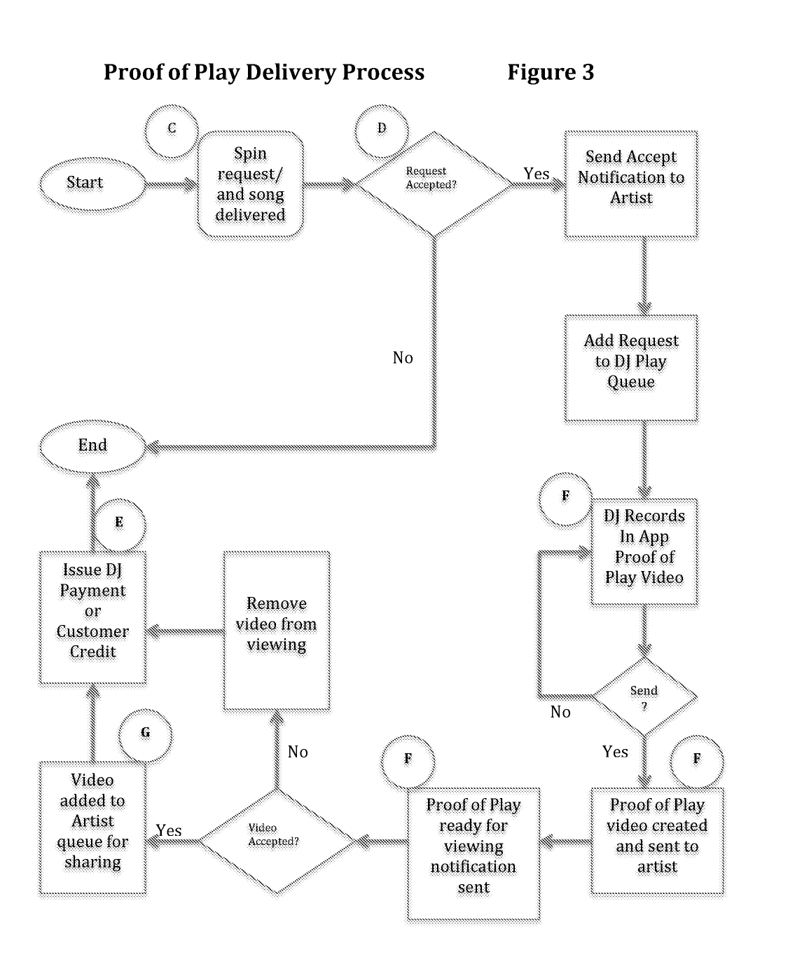

1] The system claims to be the only digital marketing platform that enables an artist to market songs directly to a club DJ for the purpose of having a song played by that DJ upon request. It is comprised of a set of processes and services that support the following functionality a) Uploading of content to be marketed, b) Submission of content to be marketed, c) Reviewing of content to be marketed, d) Acceptance and Rejection of content to be marketed, e) Payment processing for content to be marketed f) Proof that content was marketed as requested via a proof of play video that contains real time audio and video and g) Sharing of marketed digital content provided by service provider are of which are all contained within the application. A-F are marked on both FIG. 2 and FIG. 3

2] This system claims to be the only platform that supports a club or event DJ's ability to be compensated for playing requests on demand via a mobile application by presenting a video to the requestor that shows real time proof that he is playing their song in the club. Refer to FIG. 3

3] This is an embodiment of claim 1, wherein service requestors are able to access service providers by specific location, venue and date.

4] This is an embodiment of claim 1 where in service requestors are able to access service providers by name and view the location and schedule where services are offered.

5] This is an embodiment of claim of 1 wherein the service requestors are able to upload unique digital content for the purpose of delivery to service provider for the review acceptance process and play process.

6] This is an embodiment of claim 1 wherein the service requestors are able to make requests by sending unique digital content directly to service provider of choice.

7] This is an embodiment of claim 1 wherein service requestors are able to purchase services from specific service provider or multiple providers in various cities across the nation.

8] This is an embodiment of claim 1 wherein service requestors are able to track all submitted purchase requests by service provider.

9] This is an embodiment of claim 1 wherein service requestors are able to rate service provider with 5 star rating process for services rendered.

10] This is an embodiment of claim 2 wherein service providers are able to listen to and accept digital content from service requestor.

11] This is an embodiment of claim 2 where in service providers are able to manage their schedule availability by date and by location.

12] This is an embodiment of claim 2 where in service providers are able to accept requests for services.

13] This is an embodiment of claim 2 wherein service providers are able to reject digital content from service requestor.

14] This is an embodiment of claim 2 where in service providers are able to set pricing for services provided.

15] This is an embodiment of claim 2 where in service providers are able to transfer digital content outside the application via a sharing mechanism for the purpose of providing the service requested.

16] This is an embodiment of claim 2 where in service providers are able to provide proof of services rendered directly within the application.

17] This is an embodiment of claim 2 where in service requestors are able to record the event in real time for the purpose of demonstrating completion of service request.

18] This is an embodiment of claim 2 where in service requestors are able to review and retain proof of services rendered directly within the application.

19] This is an embodiment of claim 1 where in service providers are able to track the history of all services rendered directly within the application.

20] This is an embodiment of claim 13 wherein service provider is able to send pre-generated reasons for rejection of services.
